(19) United States
(12) Patent Application Publication
(10) Pub. No.: US 2013/0295482 A1
(43) Pub. Date: Nov. 7, 2013

(54) HYDROGEN SUPPLY SYSTEM FOR FUEL CELL WITH INTEGRATED MANIFOLD BLOCK

(71) Applicants: HYUNDAI MOTOR COMPANY, Seoul (KR); KIA MOTORS CORPORATION, Seoul (KR)

(72) Inventors: Duck Whan Kim, Seoul (KR); Sae Hoon Kim, Bucheon (KR); Young Bum Kum, Seoul (KR); Yong Gyu Noh, Suwon (KR); Se Kwon Jung, Yongin (KR); Hyun Joon Lee, Yongin (KR)

(73) Assignees: KIA MOTORS CORPORATION, Seoul (KR); HYUNDAI MOTOR COMPANY, Seoul (KR)

(21) Appl. No.: 13/652,783

(22) Filed: Oct. 16, 2012

(30) Foreign Application Priority Data
May 7, 2012 (KR) 10-2012-0048191

(51) Int. Cl. H01M 8/04

(52) U.S. Cl. 429/446; 429/514; 429/444

(57) ABSTRACT

Disclosed is a hydrogen supply system for a fuel cell, which has an integrated manifold block in which components for hydrogen supply are integrated and modulated. In particular, a hydrogen supply line, a hydrogen discharge line, and a hydrogen recirculation line are formed in a manifold block mounted on the outside of a plurality of stack modules of a fuel cell stack. Additionally, components of the hydrogen supply system including components for supplying and discharging hydrogen and components for recirculating hydrogen are integrally mounted in predetermined positions of the hydrogen supply line, the hydrogen discharge line, and the hydrogen recirculation line to modularize the manifold block and the components of the hydrogen supply system.

### CROSS-REFERENCE TO RELATED APPLICATION

This application claims under 35 U.S.C. §119(a) the benefit of Korean Patent Application No. 10-2012-0048191 filed May 7, 2012, the entire contents of which are incorporated herein by reference.

### BACKGROUND

(a) Technical Field

The present invention relates to a hydrogen supply system for a fuel cell with an integrated manifold block. More particularly, the present invention relates to a hydrogen supply system for a fuel cell, which has an integrated manifold block in which components for hydrogen supply are integrated and modulated. (b) Background

A typical fuel cell system mounted in a fuel cell vehicle includes a fuel cell stack for generating electricity by electrochemical reaction, a hydrogen supply system for supplying hydrogen as a fuel to the fuel cell stack, an oxygen (air) supply system for supplying oxygen-containing air as an oxidant required for the electrochemical reaction in the fuel cell stack, a thermal management system (TMS) for removing reaction heat from the fuel cell stack to outside of the fuel cell system, controlling the operational temperature of the fuel cell stack, and performing water management functions, and a system controller for controlling overall operation of the fuel cell system.

As shown in FIG. 4, a manifold block 30, which is configured to uniformly distribute the hydrogen and air required for the fuel cell reaction and coolant, respectively, is mounted on the outside of stack modules 11, 12, 13 and 14 that as a whole constitute a fuel cell stack 10. In more detail, hydrogen supply and discharge lines, air supply and discharge lines, and coolant supply and discharge lines (not shown), through which reactant gases and coolant are supplied to the stack modules 11, 12, 13 and 14, are arranged in a complex manner in the manifold block 30. Here, the configuration and operation of a conventional hydrogen supply system separately connected to the manifold block will be described with reference to FIGS. 2 and 3.

First, a hydrogen supply line 21 is connected from a hydrogen tank to the manifold block to supply hydrogen to the respective stack modules 11, 12, 13 and 14 that constitute the fuel cell stack 10. Moreover, a hydrogen supply valve 22, an ejector 23, and a pressure relief valve 24 are sequentially mounted from the front end of the hydrogen supply line 21 (i.e., at the hydrogen tank side) to the rear end thereof (i.e., at the manifold block side).

The hydrogen supply valve 22 serves to allow or block the supply of hydrogen from the hydrogen tank, the ejector 23 serves to supply sufficient hydrogen passing through the hydrogen supply valve 22 to a predetermined level and supply the hydrogen to the manifold block 30, and the pressure relief valve 24 serves to regulates the pressure of hydrogen supplied to the manifold block 30 to a predetermined level.

Moreover, a hydrogen discharge line 25 is connected to the manifold block 30 so that, after the hydrogen is supplied to the stack modules 11, 12, 13 and 14 that constitute the fuel cell stack 10, residual hydrogen and condensed water are discharged therethrough. Furthermore, a water trap 26 for discharging condensed water and a purge valve 27 for discharging a portion of hydrogen passing through the water trap 26 to the outside are sequentially mounted on the hydrogen discharge line 25.

In particular, a hydrogen recirculation line 28 runs from the purge valve 27 to the ejector 23 through the recirculation blower 29. The recirculation blower 29 sucks or blows the hydrogen passing through the purge valve 27. Accordingly, when the hydrogen resulting from the reaction in the fuel cell stack 10 is discharged to the hydrogen discharge line 25 together with condensed water, the condensed water is discharged to the outside through the water trap 26, a portion of hydrogen is discharged to the outside through the purge valve 27, and the rest of hydrogen is fed into the ejector 23 by the suction of the recirculation blower 29 and resupplied to the fuel cell stack 10 together with fresh hydrogen from the hydrogen tank.

The configuration of the manifold block for the conventional hydrogen supply system has the following drawbacks.

First, it requires more space for pipe connections between the components that constitute the hydrogen supply system (e.g., the hydrogen supply valve, the ejector, the pressure relief valve, the purge valve, the recirculation blower, etc.), which increases the overall volume of the fuel cell system, and thus it is very difficult to mount all of the components in an appropriate arrangement in a limited volumetric space such as an engine compartment.

Second, due to the increased length and complex arrangement of the hydrogen supply line and the hydrogen discharge line which constitute the pipes (i.e., transfer lines) of the hydrogen supply system, a pressure loss occurs over the hydrogen supply line and the to hydrogen discharge line, and thus a large amount of energy is required for supplying and discharging hydrogen.

Third, due to the increased length and number of hydrogen supply lines and hydrogen discharge lines, there is a high risk that hydrogen may leak from each connection fitting.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention provides a hydrogen supply system for a fuel cell system with an integrated manifold block, which reduces the overall volume and weight of the fuel cell system by modularizing components of the hydrogen supply system in a manifold block, which is manufactured by aluminum casting and mounted on the outside of a fuel cell stack, and improves the performance of a fuel cell vehicle by reducing a pressure loss occurring in a hydrogen supply line due to a reduction in the length of the hydrogen supply line.

In one aspect, the present invention provides a hydrogen supply system for a fuel cell with an integrated manifold block, characterized in that a hydrogen supply line, a hydrogen discharge line, and a hydrogen recirculation line are formed in a manifold block mounted on the outside of stack modules of a fuel cell stack. Components of the hydrogen supply system including components for supplying and discharging hydrogen and components for recirculating hydrogen are integrally mounted in predetermined positions of the hydrogen supply line, the hydrogen discharge line, and the hydrogen recirculation line, thus modularizing the manifold block and the components of the hydrogen supply system.

In an exemplary embodiment, the hydrogen supply system may further include a hydrogen supply valve mounted at an inlet of the hydrogen supply line formed on an upper surface of the manifold block. The hydrogen supply system may further include a recirculation blower mounted on the hydrogen recirculation line which is exposed through an upper surface of the manifold block. An ejector may be mounted between the hydrogen supply line and the hydrogen recirculation line in the manifold block. In case that a recirculation blower 29 is eliminated, the hydrogen discharge line 25 can be connected to the ejector 23 directly. Furthermore, a water trap and a purge valve, may be connected to the hydrogen discharge line and each mounted on a lower surface and a second side of the manifold block.

In still yet another exemplary embodiment, the hydrogen supply system may further include a controller located near the manifold block to control the operation of the recirculation blower and the water trap and the opening and closing of the valves.

Other aspects and exemplary embodiments of the invention are discussed infra.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a block diagram showing a hydrogen supply system for a fuel cell with an integrated manifold block in accordance with an exemplary embodiment of the present invention.

FIGS. 2 and 3 are schematic diagrams showing a conventional hydrogen supply system for a fuel cell.

FIG. 4 is a schematic diagram illustrating the operation of a manifold block for a fuel cell.

Reference numerals set forth in the Drawings includes reference to the following elements as further discussed below:
10: fuel cell stack
11, 12, 13 and 14: stack modules
20: hydrogen supply system
21: hydrogen supply line
22: hydrogen supply valve
23: ejector
24: pressure relief valve
25: hydrogen discharge line
26: water trap
27: purge valve
28: hydrogen recirculation line
29: recirculation blower
30: manifold block

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

The above and other features of the invention are discussed infra.

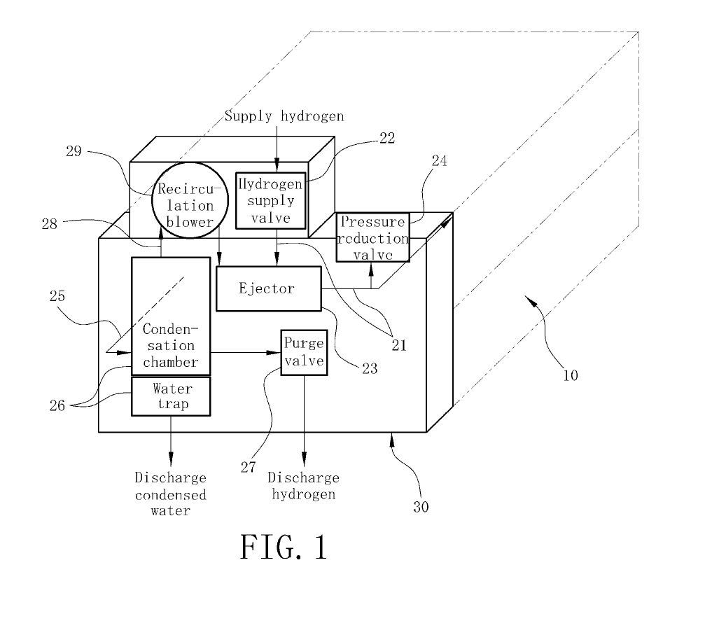

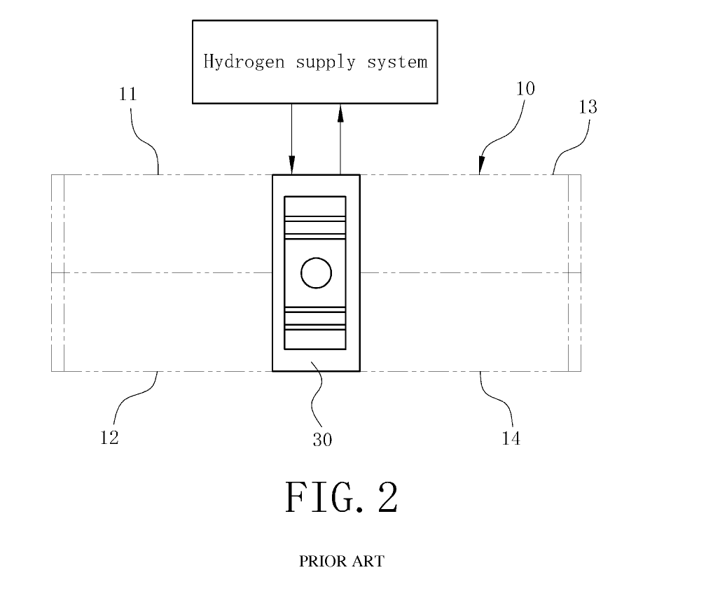

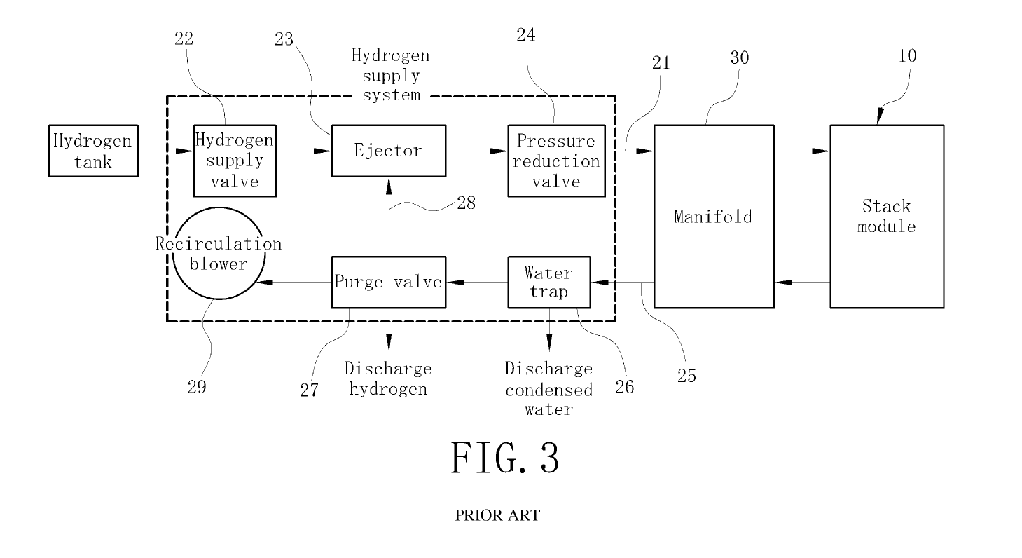

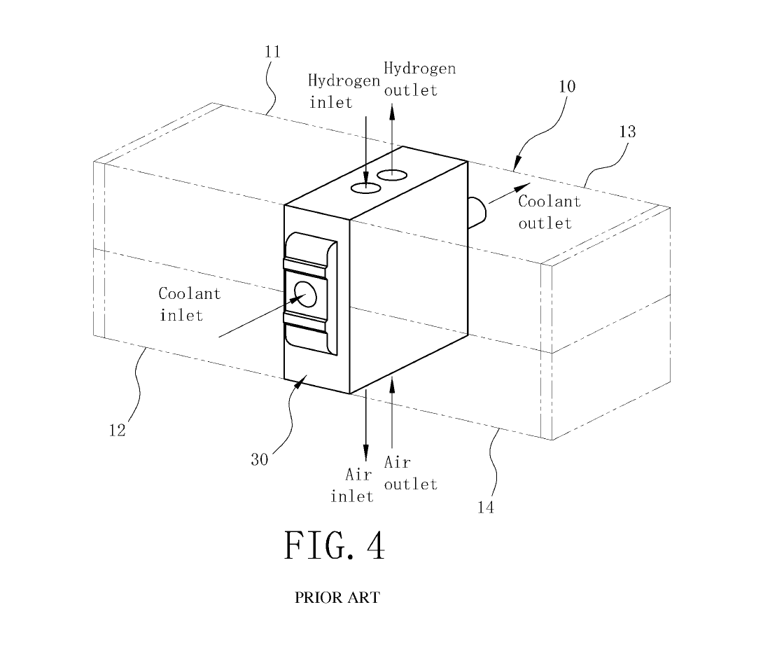

As shown in FIG. 1, the present invention is aimed at providing a hydrogen supply system 20 for a fuel cell in which various components of the hydrogen supply system 20 are mounted in appropriate positions in a manifold block 30 mounted on the outside of a fuel cell stack 10, thus modularizing the manifold block 30 and the components of the hydrogen supply system 20. To this end, the manifold block 30 may be manufactured by aluminum casting, and a hydrogen supply line 21, a hydrogen discharge line 25, and a hydrogen recirculation line 28 are optimally arranged in the manifold block 30.

Preferably, the hydrogen supply line 21 extends from the top center of the manifold block 30 to the center of the manifold block 30, further extends to a first side of the manifold block 30, and is connected to a hydrogen inlet (not shown) formed on one side of each stack module. The hydrogen discharge line 25 is connected to a hydrogen outlet (not shown) formed on one side of each stack module and extends to the bottom of the manifold block 30.

The hydrogen recirculation line 28 extends from the hydrogen discharge line 25 to a position where an ejector of the hydrogen supply line 21 is mounted.

As such, the components of the hydrogen supply system 20 including the components for supplying and discharging hydrogen and the components for recirculating hydrogen are integrally mounted in predetermined positions of the hydrogen supply line 21, the hydrogen discharge line 25, and the hydrogen recirculation line 28 formed in the manifold block 30.

Among the components of the hydrogen supply system 20, a hydrogen supply valve 22 connected to a hydrogen tank to allow or block the supply of hydrogen from the hydrogen tank is mounted at an inlet of the hydrogen supply line 21 formed on an upper surface of the manifold block 30. Moreover, among the components of the hydrogen supply system 20, an ejector 23 which supplies hydrogen passing through the hydrogen supply valve 22 to each stack module is mounted in both the hydrogen supply line 21 and the hydrogen recirculation line 28 in the manifold block 30. Thus the ejector 23 receives hydrogen from both the recirculation line 28 and the supply line 21.

A portion of the hydrogen recirculation line 28 in the manifold block 30 is exposed through an upper surface of one side of the manifold block 30, and a recirculation blower 29 for supplying hydrogen from the hydrogen discharge line 25 to the ejector 23 is mounted within the exposed portion. In case that a recirculation blower 29 is eliminated, the hydrogen discharge line 25 can be connected to the ejector 23 directly. Moreover, a water trap 26, which is connected to the hydrogen discharge line 25 in the manifold block 30 to store and discharge water discharged from the fuel cell stack together with unreacted hydrogen, is mounted on a lower surface of the manifold block 30.

Accordingly, the operation flow of the hydrogen supply system for the fuel cell, in which the manifold block and the components of the hydrogen supply system are modularized in the above-described manner, will be described.

First, when the hydrogen supply valve 22 connected to the hydrogen tank is opened, hydrogen is fed into the hydrogen supply line 21 and flows to the ejector 23. Then, the ejector 23 supplies the hydrogen from the hydrogen supply valve 22 to each stack module such that the stack modules generate electricity by electrochemical reaction. Subsequently, water produced in the stack modules by the electrochemical reaction and reacted hydrogen pass through a water trap 26 including a condensation chamber having a predetermined cross-section (e.g., 1,600 to 4,000 mm²) via the hydrogen discharge line 25. The water trap is directly connected to the recirculation blower through the hydrogen recirculation line 28. The resulting water from the reaction is discharged to the bottom and stored in the water trap 26. When the water rises above a predetermined level in the water trap 26, a discharge valve at the bottom of the water trap 26 is opened, and thus the water is discharged to the outside.

Additionally, a purge valve 27 may be mounted on the hydrogen discharge line 25 which further extends from one side of the upper space of the water trap 26, and the hydrogen recirculation line 28 is connected to the top of the upper surface of the water trap 26. Accordingly, a portion of unreacted hydrogen is discharged to the outside when the purge valve 27 is opened, and the rest of unreacted hydrogen flows into the hydrogen recirculation line 28 when the purge valve 27 is closed. Continuously, the hydrogen flowing from the hydrogen discharge line to the hydrogen recirculation line 28 is drawn into the recirculation line 28 by the operation of the recirculation blower 29 and recirculated to the ejector 23 via the same. Then, the hydrogen is mixed with fresh hydrogen flowing through the hydrogen supply valve 22 and resupplied to the stack modules.

As described above, the present invention provides the following effects.

Since the manifold block and the components of the hydrogen supply system are modularized by mounting the ejector, the purge valve, the pressure relief valve, the recirculation blower, etc. of the hydrogen supply system in appropriate positions in the manifold block, it is possible to reduce the reduce the overall volume and weight of the fuel cell system and eliminate the dead volume in the manifold block. In particular, since the respective components of the hydrogen supply system are modularized in the manifold block, the lengths of the hydrogen supply line, the hydrogen discharge line, and the hydrogen recirculation line, which connect the respective components, are reduced, which makes it possible to reduce energy loss and pressure loss of hydrogen flowing through the hydrogen supply line. Moreover, it is possible to eliminate the pipes of the hydrogen supply system separately connecting to the manifold block and eliminate the fitting for pipe connections, thus improving the assembly efficiency.

The invention has been described in detail with reference to exemplary embodiments thereof. However, it will be appreciated by those skilled in the art that changes may be made in these embodiments without departing from the principles and spirit of the invention, the scope of which is defined in the appended claims and their equivalents.

What is claimed is:

1. A hydrogen supply system for a fuel cell with an integrated manifold block comprising:
a hydrogen supply line, a hydrogen discharge line, and a hydrogen recirculation line formed in a manifold block mounted on the outside of a plurality of stack modules of a fuel cell stack, wherein the components of the hydrogen supply system including components for supplying and discharging hydrogen and components for recirculating hydrogen are integrally mounted in predetermined positions of the hydrogen supply line, the hydrogen discharge line, and the hydrogen recirculation line to modularize the manifold block and the components of the hydrogen supply system.

2. The hydrogen supply system of claim 1, further comprising a hydrogen supply valve mounted at an inlet of the hydrogen supply line formed on an upper surface of the manifold block.

3. The hydrogen supply system of claim 1, further comprising a recirculation blower mounted on the hydrogen recirculation line which is exposed through an upper surface of the manifold block.

4. The hydrogen supply system of claim 1, further comprising an ejector mounted between the hydrogen supply line and the hydrogen recirculation line in the manifold block.

5. The hydrogen supply system of claim 1, wherein the hydrogen recirculation line is connected to the ejector directly.

6. The hydrogen supply system of claim 1, further comprising a pressure relief valve, which is mounted at inlet of the hydrogen supply line formed on an upper surface of the manifold block.

7. The hydrogen supply system of claim 1, further comprising a water trap and a purge valve, which are connected to the hydrogen discharge line and each mounted on a lower surface and a second side of the manifold block.

8. The hydrogen supply system of claim 1, further comprising a controller located near the manifold block to control the operation of the recirculation blower and the water trap and the opening and closing of the valves.
